(19) United States
(12) Patent Application Publication
(10) Pub. No.: US 2017/0341582 A1
(43) Pub. Date: Nov. 30, 2017

(54) METHOD AND DEVICE FOR THE DISTORTION-FREE DISPLAY OF AN AREA SURROUNDING A VEHICLE

(71) Applicant: Conti Temic Microelectronic GmbH, Nurnberg (DE)

(72) Inventors: Markus Friebe, Gefrees (DE); Felix Löhr, Kronach (DE)

(73) Assignee: Conti Temic Microelectronic GmbH, Nurnberg (DE)

(21) Appl. No.: 15/679,603

(22) Filed: Aug. 17, 2017

Related U.S. Application Data
(63) Continuation of application No. PCT/DE2016/200074, filed on Feb. 4, 2016.

(30) Foreign Application Priority Data
Feb. 17, 2015 (DE) 10 2015 202 863.1

(51) Int. Cl. B60R 1/00; G06K 9/00

(52) U.S. Cl. CPC B60R 1/00; G06K 9/00805; B60R 2300/301; B60R 2300/306; B60R 2300/607; B60R 2300/602

(57) ABSTRACT

A camera surround view system for a vehicle includes at least one vehicle camera that supplies camera images processed by a data processing unit to generate an image of the surroundings. The image of the surroundings being displayed on a display unit. The data processing unit re-projects textures, which are detected by the vehicle cameras, on an adaptive re-projection surface, which is similar to the area surrounding the vehicle, the re-projection surface being calculated based on sensor data provided by vehicle sensors. The data processing unit adapts the re-projection surface depending on a position and an orientation of a virtual camera.

### CROSS-REFERENCE TO RELATED APPLICATIONS

This application claims the benefit of PCT Application PCT/DE2016/200074, filed Feb. 4, 2016, which claims priority to German Application DE 10 2015 202 863.1, filed Feb. 17, 2015. The disclosures of the above applications are incorporated herein by reference.

### TECHNICAL FIELD

The disclosure relates to a method and a device for a distortion-free display of an area surrounding a vehicle, in particular a road vehicle, which has a camera surround view system.

### BACKGROUND

Vehicles are increasingly being equipped with driver assistance systems, which assist the driver during the performance of driving maneuvers. These driver assistance systems contain, in part, camera surround view systems that make it possible to display the area surrounding the vehicle to the driver of the vehicle. Such camera surround view systems include one or more vehicle cameras which supply camera images that are pieced together by a data processing unit of the camera surround view system to form an image of the area surrounding the vehicle. The image of the area surrounding the vehicle is, in this case, displayed on a display unit. Conventional camera-based driver assistance systems project texture information from the camera system on a static projection surface, for example on a static two-dimensional base surface or on a static three-dimensional shell surface.

However, the serious disadvantage of such systems is that objects in the area surrounding the vehicle are displayed in an extremely distorted manner, since the textured re-projection surface is static and does not therefore correspond to the real surroundings of the camera system or is not similar thereto. As a result, extremely distorted objects can be displayed, which form disruptive artifacts.

### SUMMARY

Therefore, it is desirable to provide a device and a method for the distortion-free display of an area surrounding a vehicle, which prevents such distorted artifacts being shown, in order to show obstacles in the area surrounding the vehicle in a manner which is as clearly visible and as free of distortion as possible.

One aspect of the disclosure provides a camera surround view system for a vehicle. The camera surround view system includes at least one vehicle camera which supplies camera images that are processed by a data processing unit in order to generate a surround view image or an image of the surroundings. The image of the surroundings being displayed on a display unit. The data processing unit re-projects textures, which are detected by the vehicle cameras, on an adaptive re-projection surface, which is similar to the area surrounding the vehicle. The re-projection surface being calculated based on sensor data provided by vehicle sensors, where the data processing unit adapts the re-projection surface depending on a position and/or an orientation of a virtual camera.

Implementations of the disclosure may include one or more of the following optional features. In some implementations, the sensor data provided by the vehicle sensors accurately show the area surrounding the vehicle.

In some examples, the sensor data include parking distance data, radar data, LiDAR data, camera data, laser scanning data and/or movement data. The adaptive re-projection surface may include a dynamically modifiable grid.

In some implementations, the grid of the re-projection surface is dynamically modified depending on the sensor data provided. The grid of the re-projection surface may be a three-dimensional grid.

In some implementations, the display unit is a touchscreen and the position and/or the orientation of the virtual camera can be adjusted by a user via the touchscreen.

Another aspect of the disclosure provides a driver assistance system having a camera surround view system integrated therein. The system includes at least one vehicle camera that supplies camera images that are processed by a data processing unit in order to generate a surround view image. The surround view image being displayed on a display unit. The data processing unit re-projects textures, which are detected by the vehicle cameras, on an adaptive re-projection surface, which is similar to the area surrounding the vehicle. The re-projection surface being calculated based on sensor data provided by vehicle sensors.

In some implementations, the disclosure provides a method for the distortion-free display of an area surrounding a vehicle. The method includes generating camera images of the area surrounding the vehicle by vehicle cameras, and processing the generated camera images in order to generate an image of the area surrounding the vehicle. The method also includes re-projecting textures, which are detected by the vehicle cameras, on an adaptive re-projection surface, which is similar to the area surrounding the vehicle, The re-projection surface being calculated on the basis of sensor data provided by vehicle sensors. The method also includes adapting the re-projection surface depending on a position and/or an orientation of a virtual camera which supplies a bird's eye perspective camera image of the vehicle.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a block diagram illustrating an exemplary camera surround view system.

FIG. 2 shows a flow chart to illustrating an exemplary method for the distortion-free display of an area surrounding a vehicle.

FIG. 3 shows a schematic representation for explaining an exemplary mode of operation of the method and the camera surround view system.

Like reference symbols in the various drawings indicate like elements.

### DETAILED DESCRIPTION

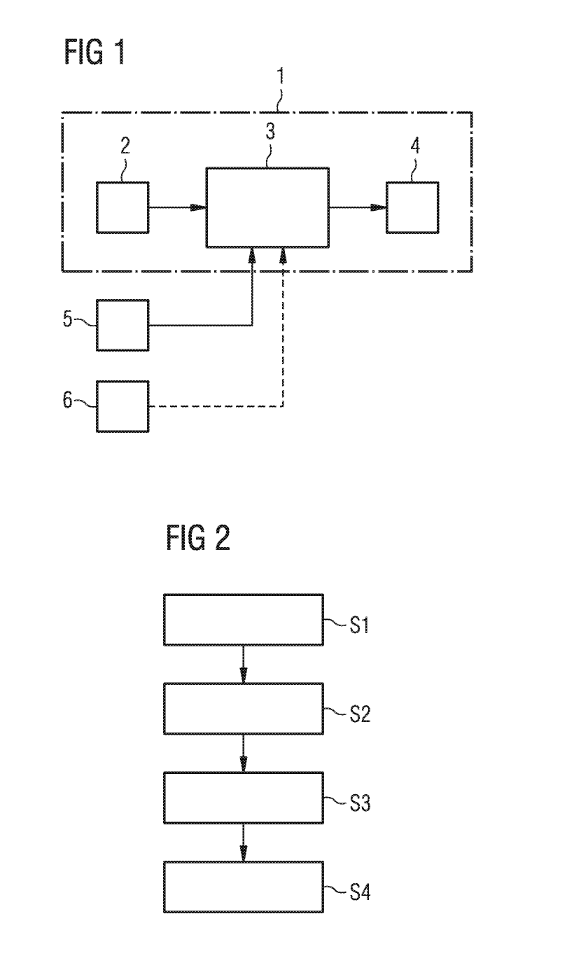

Referring to FIG. 1, a camera surround view system 1 in the example shown includes multiple components. The camera surround view system 1 includes, for example, at least one vehicle camera 2 which supplies camera images that are processed by a data processing unit 3 of the camera surround view system 1 to produce a surround view image or an image of the area surrounding the vehicle. The surround view images or images of the area surrounding the vehicle generated by the data processing unit 3 are displayed on a display unit 4. The data processing unit 3 calculates an adaptive re-projection surface based on sensor data provided by vehicle sensors 5. Textures, which are detected by the vehicle cameras 2 of the camera surround view system 1, are re-projected on the calculated adaptive re-projection surface, which is similar to the area surrounding the vehicle, as a result of which distortions or distorted artifacts are minimized or eliminated.

The sensors 5 shown in FIG. 1 are, for example, sensors of a parking distance control system or parking distance regulating system. In addition, the sensors of the vehicle may be radar sensors or LiDAR sensors. In some implementations, the sensor data are supplied by further vehicle cameras 2, such as, for example a stereo camera or a mono camera, to calculate the adaptive re-projection surface. In some examples, the sensor data are provided by a laser scanning system of the vehicle. Movement data or structure data may also be used by the data processing unit 3 to calculate the re-projection surface. The sensor data provided by the vehicle sensors 5 reproduce the area surrounding the vehicle or objects in the area surrounding the vehicle very accurately. The objects are, for example, other vehicles which are located in the immediate surroundings of the vehicle, for example within a radius of up to five meters. In addition, these objects may also be pedestrians who are passing the vehicle in the immediate vicinity at a distance of up to five meters. The objects may also be other obstacles such as, for example, poles to delimit a parking area.

The re-projection surface calculated by the data processing unit 3 based on the sensor data may include a dynamically modifiable grid or mesh. In some examples, this grid of the re-projection surface is dynamically modified depending on the sensor data provided. The grid of the re-projection surface may be a three-dimensional grid. The re-projection surface calculated by the data processing unit 3 is not static, but can be dynamically and adaptively adjusted to the current sensor data that are supplied by the vehicle sensors 5. In some examples, these vehicle sensors 5 can include a mono front camera or a stereo camera. In addition, the sensor units 5 can include a LiDAR system which supplies data or a radar system which transmits radar data from the surroundings to the data processing unit 3. The data processing unit 3 may contain one or more microprocessors that process the sensor data and calculate a re-projection surface therefrom in real time. Textures, which are detected by the vehicle cameras 2, are projected or re-projected onto this calculated projection surface, which is similar to the area surrounding the vehicle. The display of the vehicle cameras 2 may vary. In some examples, the vehicle has four vehicle cameras 2 on four different sides of the vehicle. The vehicle may be a road vehicle, for example, a truck or a car. The textures of the surroundings detected by the camera 2 of the camera system are re-projected by the adaptive re-projection surface with the camera surround view system 1, to reduce or eliminate the aforementioned artifacts. Therefore, the quality of the area surrounding the vehicle shown is considerably improved by the camera surround view system 1. Objects in the area surrounding the vehicle, for example other vehicles parked in the vicinity or persons located in the vicinity, appear less distorted than in the case of systems which use a static re-projection surface.

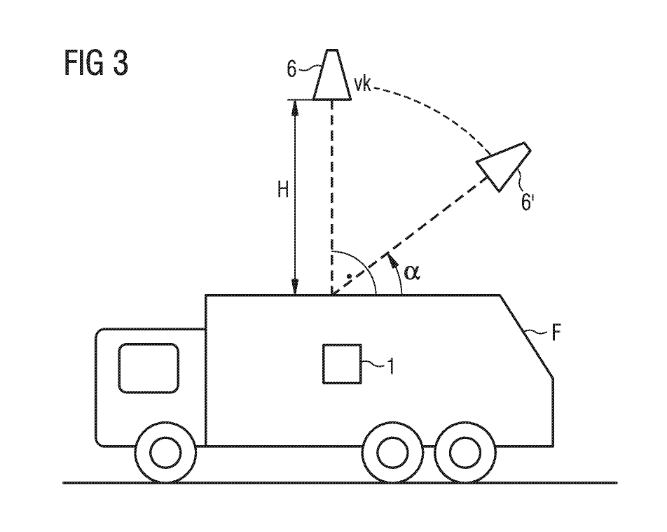

The data processing unit 3 controls a virtual camera 6 as shown in FIG. 3. As can be seen in FIG. 3, the virtual camera 6, which is controlled by the data processing unit 3, supplies camera images of the vehicle F from a bird's eye perspective. In a basic adjustment, the virtual camera 6 is arranged virtually at an angle of 90° and a height H above the bodywork of the vehicle F. The camera image of the virtual camera 6 may be calculated by the data processing unit 3 from camera images of surround view cameras that are provided on the vehicle F. The virtual camera 6 has a camera orientation relative to the vehicle F as well as a relative position to the vehicle F. The data processing unit 3 of the camera surround view system 1 adapts the re-projection surface depending on a position and an orientation of the virtual camera 6. The position and the orientation of the virtual camera 6 may be adjusted. As shown in FIG. 3, starting from its vertical position, the virtual camera 6 can, for example, be inclined at an angle of 90° above the vehicle bodywork, where it assumes an angle of inclination a, for example, 45°. The distance or the height of the vehicle camera 6 with respect to the vehicle F remains constant in the example shown in FIG. 3. In addition to the relative position, it is additionally possible to adjust the orientation of the vehicle camera 6 as well. In some examples, the data processing unit 3 reads out the current position and orientation of the virtual camera 6 relative to the vehicle F from a parameter memory of the virtual camera 6. Depending on the read-out parameters of the virtual camera 6, the adaptive re-projection surface is then adjusted or adapted by the data processing unit 3 so that as much texture or camera information as possible is shown in a distortion-free manner on the display unit 4 and, at the same time, obstacles in the immediate surroundings of the vehicle F are easily identifiable for the driver of the vehicle F. In some examples, the display unit 4 is a touchscreen. In some examples, a driver or user of the vehicle F can touch the touchscreen and thereby adjust or align the position and/or the orientation of the virtual camera 6 to identify obstacles in the area immediately surrounding the vehicle, for example poles which mark a delimited parking area, as clearly as possible. In some examples, it is also possible for the user to adjust the distance or the height of the virtual camera 6 above the observed vehicle F to identify an obstacle in the area surrounding the vehicle as clearly and in as much detail as possible. An obstacle can be any object that prevents the vehicle F from driving around on the roadway surface, for example a pile of snow or a pole for delimiting a parking area.

FIG. 2 shows a flow chart that illustrates an example of the method according to the disclosure for the distortion-free display of an area surrounding a vehicle.

In a first step S1, camera images of the area surrounding the vehicle are generated by cameras 2 of the vehicle F. For example, the camera images are generated by multiple vehicle cameras 2 that are mounted on different sides of the vehicle.

The generated camera images are then processed in step S2 to generate an image of the area surrounding the vehicle. In some examples, the processing of the generated camera images is carried out by a data processing unit 3, as shown in FIG. 1. The camera images may be processed in real time to generate a corresponding image of the surroundings.

In a further step S3, a re-projection surface is first calculated based on sensor data provided and subsequently textures, which are detected by the vehicle cameras, are re-projected on this adaptive calculated re-projection surface. The adaptive re-projection surface includes a dynamically modifiable grid which is dynamically modified depending on the sensor data provided. This grid may be a three-dimensional grid.

In a step S4, the re-projection surface is adapted by the data processing unit 3 depending on a position and/or an orientation of a virtual camera 6 that supplies a bird's eye perspective camera image of the vehicle F from above.

In some implementations, the method shown in FIG. 2 may be implemented by a computer program that contains computer commands that can be executed by a microprocessor. In some examples, this program is stored on a data carrier or in a program memory.

A number of implementations have been described. Nevertheless, it will be understood that various modifications may be made without departing from the spirit and scope of the disclosure. Accordingly, other implementations are within the scope of the following claims.

What is claimed is:

1. A camera surround view system for a vehicle, the system comprising:
at least one vehicle camera supplying camera images;
a data processing unit processing the supplied camera images and generating an image of the surroundings; and
a display unit displaying the image of the surroundings;
wherein the data processing unit re-projects textures, which are detected by the vehicle cameras, on an adaptive re-projection surface, which is similar to an area surrounding the vehicle, the re-projection surface being calculated on the basis of sensor data provided by vehicle sensors, wherein the sensor data provided by the vehicle sensors reproduce the area surrounding the vehicle, wherein the sensor data comprise parking distance data, radar data, LiDAR data, laser scanning data and/or movement data, and wherein the data processing unit adapts the re-projection surface depending on a position and an orientation of a virtual camera.

2. The camera surround view system of claim 1, wherein the calculated adaptive re-projection surface comprises a dynamically modifiable grid.

3. The camera surround view system of claim 2, wherein the grid of the re-projection surface is a three-dimensional grid which can be dynamically modified depending on the sensor data provided.

4. The camera surround view system of claim 1, wherein the display unit is a touchscreen and the position and the orientation of the virtual camera is adjusted by a user.

5. A driver assistance system for a vehicle having a camera surround view system, the camera surround view system comprising:
at least one vehicle camera supplying camera images;
a data processing unit that processes the supplied camera images to generate an image of the surroundings; and
a display unit displaying the image of the surroundings;
wherein the data processing unit re-projects textures, which are detected by the vehicle cameras, on an adaptive re-projection surface, which is similar to an area surrounding the vehicle, the re-projection surface being calculated on the basis of sensor data provided by vehicle sensors, wherein the sensor data provided by the vehicle sensors reproduce the area surrounding the vehicle, wherein the sensor data comprise parking distance data, radar data, LiDAR data, laser scanning data and/or movement data, and wherein the data processing unit adapts the re-projection surface depending on a position and an orientation of a virtual camera.

6. A method for a distortion-free display of an area surrounding a vehicle, the method comprising:
generating camera images of the area surrounding the vehicle by vehicle cameras;
processing the generated camera images to generate an image of the area surrounding the vehicle; and
re-projecting textures detected by the vehicle cameras on an adaptive re-projection surface, which is similar to the area surrounding the vehicle, the re-projection surface calculated based on sensor data provided by vehicle sensors, wherein the sensor data provided by the vehicle sensors show the area surrounding the vehicle, and the sensor data include parking distance data, radar data, LiDAR data, laser scanning data and/or movement data; and
adapting the re-projection surface depending on a position and/or an orientation of a virtual camera which supplies a bird's eye perspective camera image of the vehicle.

7. The method of claim 6, wherein the adaptive re-projection surface comprises a dynamically modifiable grid.

8. The method according to claim 7, wherein the grid of the re-projection surface is a three-dimensional grid which is dynamically modified depending on the sensor data provided.

9. The method of claim 8, wherein the position and the orientation of the virtual camera are adjusted by a user via a user interface.

10. A computer program having commands, which executes a method for a distortion-free display of an area surrounding a vehicle, the method comprising:
generating camera images of the area surrounding the vehicle by vehicle cameras;
processing the generated camera images to generate an image of the area surrounding the vehicle; and
re-projecting textures detected by the vehicle cameras on an adaptive re-projection surface, which is similar to the area surrounding the vehicle, the re-projection surface calculated based on sensor data provided by vehicle sensors, wherein the sensor data provided by the vehicle sensors show the area surrounding the vehicle, and the sensor data include parking distance data, radar data, LiDAR data, laser scanning data and/or movement data; and
adapting the re-projection surface depending on a position and/or an orientation of a virtual camera which supplies a bird's eye perspective camera image of the vehicle.

11. A road vehicle having a driver assistance system and a camera surround view system, the camera surround view system comprising:
at least one vehicle camera supplying camera images;
a data processing unit that processes the supplied camera images to generate an image of the surroundings; and
a display unit displaying the image of the surroundings;
wherein the data processing unit re-projects textures, which are detected by the vehicle cameras, on an adaptive re-projection surface, which is similar to an area surrounding the vehicle, the re-projection surface being calculated on the basis of sensor data provided by vehicle sensors, wherein the sensor data provided by the vehicle sensors reproduce the area surrounding the vehicle, wherein the sensor data comprise parking distance data, radar data, LiDAR data, laser scanning data and/or movement data, and wherein the data processing unit adapts the re-projection surface depending on a position and an orientation of a virtual camera.
